(19) United States
(12) Patent Application Publication
(10) Pub. No.: US 2015/0137733 A1
(43) Pub. Date: May 21, 2015

(54) ELECTRONIC APPARATUS AND METHOD OF CHARGING THE SAME

(71) Applicant: Samsung Electronics Co., Ltd, Suwon-si (KR)

(72) Inventor: Sang-hoon SI, Suwon-si (KR)

(73) Assignee: Samsung Electronics Co., Ltd, Suwon-si (KR)

(21) Appl. No.: 14/254,231

(22) Filed: Apr. 16, 2014

(30) Foreign Application Priority Data
Nov. 18, 2013 (KR) 10-2013-0139827

(51) Int. Cl. H02J 7/00

(52) U.S. Cl. CPC H02J 7/0042; H02J 7/0027
USPC 320/101; 320/137

(57) ABSTRACT

An electronic apparatus includes a user interface configured to display preset information, a battery configured to supply a power to the user interface, and a charger provided with a vibrator that is movable in the electronic apparatus and configured to convert kinetic energy caused by movement of the vibrator into electric energy to charge the battery.

### CROSS-REFERENCE TO RELATED APPLICATIONS

This application claims priority under 35 U.S.C. §119(a) to Korean Patent Application No. 10-2013-0139827, filed on Nov. 18, 2013, in the Korean Intellectual Property Office, the disclosure of which is incorporated herein by reference.

### BACKGROUND OF THE INVENTION

1. Field of the Invention

The present disclosure relates to an electronic apparatus and a method of charging the same, and more particularly to an electronic apparatus and a method of charging the same, which can charge a battery of the electronic apparatus using kinetic energy caused by a user's motion.

2. Description of the Related Art

Recently, with the development of computer technology, a wearable computer, which is provided on clothes to be worn by a user, has been introduced. The wearable computer is a computer which puts PC functions onto clothes. The wearable computer has been first developed for military training, and the province of the wearable computer has been gradually extended up to fashion/mobile communication appliances and digital products in everyday life.

Since the wearable computer is put on a user's body in a wearable shape, it is customary to implement the wearable computer with a small size, and thus it is difficult to provide a large-capacity battery in the wearable computer, since a large-capacity battery is usually relatively large in size.

Unless the large-capacity battery is provided, the operating time of the wearable computer becomes insufficient for normal or extended use, and thus there is a need for a method of easily charging the wearable computer. More particularly, there is a need for a method of charging the wearable computer while the wearable computer is in use.

### SUMMARY OF THE INVENTION

Exemplary embodiments of the present general inventive concept provide an electronic apparatus and a method of charging the same, which can charge a battery of the electronic apparatus using kinetic energy caused by a user's motion.

Additional features and utilities of the present general inventive concept will be set forth in part in the description which follows and, in part, will be obvious from the description, or may be learned by practice of the general inventive concept.

Exemplary embodiments of the present general inventive concept provide an electronic apparatus including a user interface configured to display preset information, a battery configured to supply a power to the user interface, and a charger provided with a vibrator that is movable in the electronic apparatus and configured to convert kinetic energy caused by movement of the vibrator into electric energy to charge the battery.

The charger may include the vibrator, a post having a space of a preset shape in which the vibrator is movable, and a piezoelectric thin film arranged on at least one side of the post.

The piezoelectric thin film may convert impact pressure applied to the piezoelectric thin film of the vibrator into the electric energy using a piezoelectric effect.

The vibrator may be a permanent magnet having an N-pole arranged in a first direction of the post and an S-pole arranged in an opposite direction of the post, and the charger may further include a coil surrounding an outer portion of the post.

The coil may generate an induced electromotive force caused by movement of the permanent magnet.

The charger may include a first auxiliary permanent magnet, a main permanent magnet, and a second auxiliary permanent magnet, which are successively arranged in the space of the post between two piezoelectric thin films.

The first or second auxiliary permanent magnet may include an S-pole arranged in the first direction of the post and an N-pole arranged in the opposite direction of the post.

The coil may be arranged on an outer surface of the post on a path in which the main permanent magnet moves.

The coil may be arranged on an outer surface of the post on a path in which the permanent magnet moves.

The post may be in a cylindrical shape having a preset permeability of magnetic flux.

The battery may be chargeable using a DC power provided from an external source.

The electronic apparatus may include a plurality of chargers.

The plurality of chargers may be arranged in different directions on the electronic apparatus.

The electronic apparatus may be in the form of a watch that is wearable on a user's wrist.

The charger may be arranged so that the vibrator moves in a direction that is perpendicular to a display direction of the user interface.

The charger may be arranged on a watch strap of the watch.

The preset information may be current time information.

Exemplary embodiments of the present general inventive concept also provide a method of charging an electronic apparatus that displays preset information, the method including moving a vibrator in the electronic apparatus in accordance with a user's motion, converting kinetic energy caused by movement of the vibrator into electric energy, and charging a battery using the converted electric energy.

The converting may convert impact pressure applied to a piezoelectric thin film of the vibrator into the electric energy using a piezoelectric effect.

The vibrator may be a permanent magnet, and the converting may use an induced electromotive force of a coil on a moving path of the permanent magnet caused by movement of the permanent magnet.

A non-transitory computer-readable medium may contain computer-readable codes as a program to execute the method of charging the electronic apparatus.

Exemplary embodiments of the present general inventive concept also provide an electronic apparatus including a battery, and a charger including a vibrator configured to move along a predefined path and thereby generate kinetic energy according to a movement of the electronic apparatus, the charger being configured to convert the kinetic energy into electric energy to charge the battery.

The predefined path may be substantially linear.

The electronic apparatus may further include a sensor to detect a direction of the movement of the electronic apparatus. The predefined path of the vibrator may be changed according to the detected direction.

The charger may be further configured to charge the battery according to electric energy received from an external source.

The communication interface may be configured to charge the battery according to electric energy received from the external device.

The movement of the electronic apparatus may correspond to a movement of a user wearing the electronic apparatus.

Exemplary embodiments of the present general inventive concept also provide a method of charging an electronic apparatus, the method including moving a vibrator in the electronic apparatus along a predefined path to generate kinetic energy according to a movement of the electronic apparatus, converting the kinetic energy into electric energy, and charging a battery with the electric energy.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating the shape of an electronic apparatus according to an exemplary embodiment of the present general inventive concept;

FIG. 2 is a block diagram illustrating the detailed configuration of the electronic apparatus of FIG. 1;

FIG. 3 is a view illustrating a charger according to an exemplary embodiment of the present general inventive concept;

FIG. 4 is a view illustrating the operation of the charger of FIG. 3;

FIG. 5 is a view illustrating a charger according to an exemplary embodiment of the present general inventive concept;

FIG. 6 is a view illustrating a charger according to an exemplary embodiment of the present general inventive concept;

FIG. 7 is a view illustrating a charger according to an exemplary embodiment of the present general inventive concept;

FIG. 8 is a view illustrating a charging module according to an exemplary embodiment of the present general inventive concept;

FIG. 9 is a view illustrating a charging module according to an exemplary embodiment of the present general inventive concept;

FIG. 10 is a view illustrating a charger according to an exemplary embodiment of the present general inventive concept;

FIG. 11 is a view illustrating a charger according to an exemplary embodiment of the present general inventive concept;

FIGS. 12 and 13 are views illustrating various arrangement examples of the charger; and

FIG. 14 is a flowchart illustrating a charging method according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

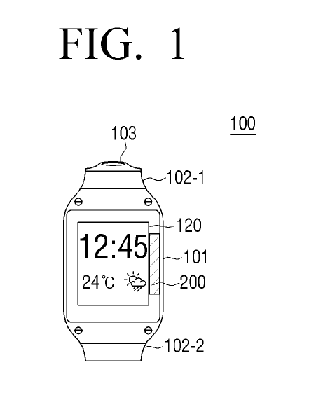

FIG. 1 is a view illustrating the shape of an electronic apparatus 100 according to an exemplary embodiment of the present general inventive concept.

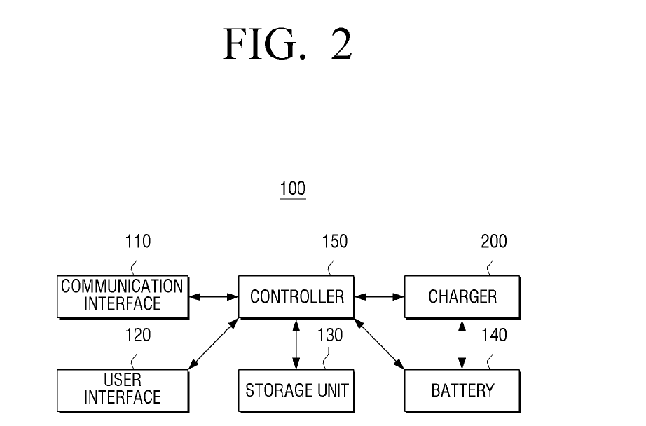

Referring to FIG. 1, the electronic apparatus 100 according to this exemplary embodiment displays preset information using a power provided from a battery 140 (illustrated in FIG. 2). The electronic apparatus 100 charges the battery 140 using a charger 200 included therein. As illustrated, the electronic apparatus 100 may be a smart watch in the form of a watch. Here, the smart watch is a watch-shaped electronic apparatus which not only displays time information as a general function of the watch but also displays other various kinds of information in association with other devices.

Accordingly, the electronic apparatus 100 according to this exemplary embodiment includes a main body 101 on which a user interface 120 is arranged, and watch straps 102-1 and 102-2 that fix the main body 101 to a user's wrist.

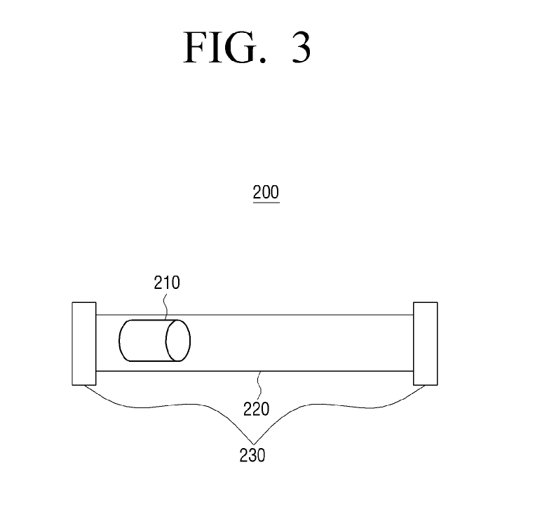

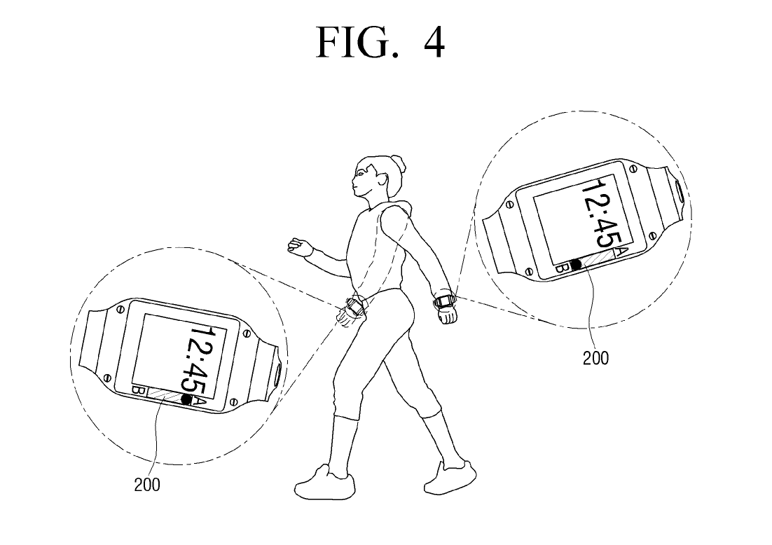

In the main body 101, a user interface 120, a battery 140, and a charger 200 are arranged. In particular, the charger 200 is arranged so that a vibrator 210 (illustrated in FIG. 3) vibrates in a direction that is perpendicular to a display direction of the user interface 120, which coincides with a vibration direction caused by a user's swinging arm while the user is walking. The detailed charging operation of the charger 200 will be described later with reference to FIG. 4.

The watch straps 102-1 and 102-2 function to make the main body 101 fixed to the user's wrist, and an image capturer 103 that captures an image may be provided thereon. Accordingly, the image capturer 103 and the main body 101 may be physically and electrically connected to each other.

As described above, the electronic apparatus 100 according to this exemplary embodiment can charge the battery 140 using the charger 200 through conversion of kinetic energy caused by user's motion into electric energy, and thus the operating time of the electronic apparatus 100 can be increased.

Although the watch type wearable electronic apparatus 100 is illustrated as an example, the electronic apparatus 100 may be a notebook computer, a tablet computer, an MP3 player, a PMP (Portable Multimedia Player), or a portable phone, which can be moved by a user or can be operated by a moving user. The electronic apparatus 100 may further be any kind of wearable computer, for example clothing, which may be moved or operated by a user wearing the wearable computer.

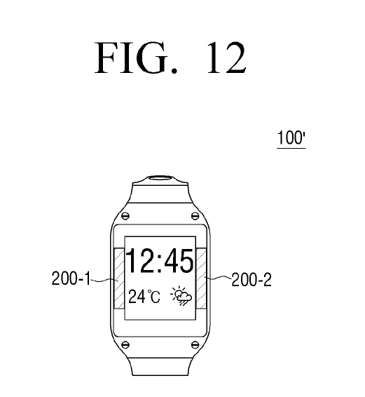

On the other hand, although it is exemplified that time information is displayed using an electronic display device (e.g., LCD or AMOLED), the electronic apparatus 100 may be provided with a plurality of mechanical movements, for example gears and hands as per an analog timepiece, and may display time using the provided movements. Although it is illustrated that only one charger 200 is provided in the electronic apparatus 100, a plurality of chargers 200 may be provided therein. Such an example will be described later with reference to FIG. 12.

FIG. 2 is a block diagram illustrating the detailed configuration of the electronic apparatus 100 of FIG. 1.

Referring to FIG. 2, the electronic apparatus 100 includes a communication interface 110, a user interface 120, a storage unit 130, a battery 140, a charger 200, and a controller 150. Here, the electronic apparatus 100 may be a notebook computer, a tablet computer, an MP3 player, a PMP (Portable Multimedia Player), a portable phone, an electronic watch, or other wearable computer.

The communication interface 110 is provided to connect to a host device (not illustrated) or the Internet by wire or wirelessly. Specifically, the communication interface 110 may perform data transmission/reception with respect to an external device (e.g., a smart phone, a PC, etc., not illustrated) through a wireless communication method, such as Bluetooth, RF communications, Wi-Fi, or Near Field Communication (NFC). In this case, data that is transmitted or received may be not only content information, such as weather information, but also telephone or music streaming data that is transferred from the smart phone or other external device.

The communication interface 110 may include a port be connected to the external device in a wired communication method, and may input/output various kinds of data in the connected communication method. The port that is to be connected to the external device by wire may also be used to charge the battery 140. That is, the battery 140 may be charged using a DC power that is input through the corresponding port. Furthermore, the battery 140 may be charged according to electric energy received by any other method, for example wireless transmission of electric energy.

The user interface 120 may perform various operations corresponding to functions supported by the electronic apparatus 100 and may display various kinds of information provided from the electronic apparatus 100. The user interface 120 may be implemented by a touch screen on which both input and output functions are performed.

The storage unit 130 stores a program to operate the electronic apparatus 100. Specifically, the storage unit 130 may store a program that is a set of various kinds of commands that are required to operate the electronic apparatus 100. Here, the program includes not only application programs to provide specified services but also an operating system to operate the application programs.

The storage unit 130 may be implemented by a storage medium in the electronic apparatus 100 or an external storage medium, for example, a removable disk including a USB memory or a web server through a network.

The battery 140 supplies the power to respective configurations in the electronic apparatus 100. Specifically, the battery 140 may include a sensor to sense the battery state. The battery 140 may supply the power according to the operating state of the electronic apparatus 100 under the control of the controller 150, to be described later.

On the other hand, the battery 140 may be charged through an externally provided DC power or using the electric energy generated from the charger 200 to be described later. Although not illustrated, the battery 140 may be also charged in a wireless charging method. In this exemplary embodiment of the present general inventive concept, the battery 140 is charged using the electric energy that is transferred from the charger 200 as it is. However, the battery 140 may also be charged after the electric energy that is generated from the charger 200 is rectified and/or transformed.

The charger 200 may be provided with the vibrator 210 that is movable in the electronic apparatus 100, and may convert the kinetic energy caused by the movement of the vibrator 210 into electric energy to charge the battery 140. The detailed configuration and operation of the charger 200 will be described later with reference to FIGS. 3 to 11.

The controller 150 controls the respective configurations of the electronic apparatus 100. Specifically, the controller 150 determines the operating state of the electronic apparatus 100. For example, if a user's input is not made for a preset time or no work is done for the preset time, the controller 150 may determine the operating state of the electronic apparatus 100 as a power saving state.

On the other hand, if a user's touch is input through the user interface 120 or if data or a wakeup command is received from an external device (not illustrated) through the communication interface 110 in the power saving state, the controller 150 may determine the operating state of the electronic apparatus 100 as a normal state.

Further, the controller 150 may determine the operating state of the electronic apparatus 100 according to the battery state of the electronic apparatus 100. Specifically, if the battery residual amount is smaller than a preset residual amount, the controller 150 may determine the operating state of the electronic apparatus 100 as the power saving state.

The controller 150 may control the respective configurations of the electronic apparatus 100 to correspond to the determined operating state. Specifically, if the operating state of the electronic apparatus 100 is changed to the power saving state, the controller 150 may control the user interface 120 not to display the preset information.

Further, the controller 150 may control the operation of the charger 200 according to the battery state of the electronic apparatus 100. Specifically, in a state where the battery 140 is fully charged, the controller 150 may control the charger 200 not to output the generated electric energy.

As described above, the electronic apparatus 100 according to this exemplary embodiment can charge the battery 140 through conversion of the kinetic energy caused by the user's motion into the electric energy, and thus the operating time of the electronic apparatus 100 can be increased.

FIG. 3 is a view illustrating an implementation example of the charger in FIG. 2. Specifically, the charger 200 according to an exemplary embodiment of the present general inventive concept generates electric energy using a piezoelectric effect.

Referring to FIG. 3, the charger 200 according to the exemplary embodiment includes the vibrator 210, a post 220, and a piezoelectric thin film 230.

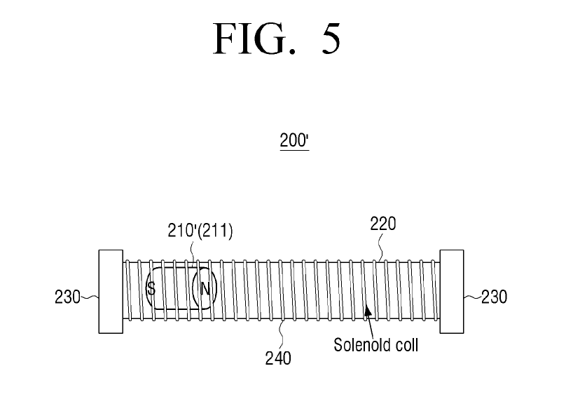

The vibrator 210 moves in a space provided inside the post 220 to correspond to vibration of the electronic apparatus 100. The vibrator 210 may have a shape that corresponds to the shape of the interior of the post 220. For example, if the shape of the interior of the post 220 is a rectangular prism, the vibrator 210 may have a rectangular prism shape. By contrast, if the shape of the interior of the post 220 is a cylinder, the vibrator 210 may have a cylindrical shape. Further, the vibrator 210 may have a weight enough to apply a sufficient impact pressure when it collides with the piezoelectric thin film 230. The impact pressure is described later. In an exemplary embodiment of FIG. 3, the material of the vibrator 210 is not limited, but it is preferable that the vibrator 210 is a permanent magnet 211 in exemplary embodiments of FIGS. 5 to 10. In this case, it is preferable that the permanent magnet 211 has high coercive force, and the N-pole of the permanent magnet 211 is arranged in one direction of the post 220 and the S-pole of the permanent magnet 211 is arranged in the other direction of the post 220. This will be described later with reference to FIG. 5.

The post 220 has a space formed in a preset shape in which the vibrator 210 is movable. That is, the post 220 may be in a circular shape, and may have a circular space therein. That is, the post 220 may be in a cylindrical shape. The height (or length) of the post 220 may be set through a plurality of experiments or simulations depending on the particular embodiment of the present general inventive concept. Specifically, if the length of the post 220 is too short, sufficient impact energy may not be generated on the piezoelectric thin film 230, while if the length of the post 220 is too long, the vibrator 210 may not collide with the piezoelectric thin film 230 when the user rotates his/her arm. Accordingly, the length of the post 220 may be optimized through various simulations and experiments.

The post 220 is arranged in the direction in which the vibrator 210 vibrates to correspond to the moving direction of the electronic apparatus 100. Specifically, if the electronic apparatus 100 is implemented by a smart watch, the post 220 may be arranged in the direction (defined herein as a vertical direction) that is perpendicular to the display direction (defined herein as a horizontal direction) of the user interface 120. That is, if the user interface 120 is displayed in the X-axis direction, the long axis of the post, i.e. the travel direction of the vibrator 210, may be arranged in the Y-axis direction.

On the other hand, it is preferable that the post 220 is made of a heatproof material against the movement of the vibrator 210, and in exemplary embodiments of FIGS. 5 to 10, it is preferable that the post 220 additionally has good permeability of magnetic flux.

The piezoelectric thin film 230 is arranged on at least one side of the post to convert the impact pressure applied to the piezoelectric thin film 230 of the vibrator 210 into electric energy using the piezoelectric effect. Here, the piezoelectric effect is the property of certain materials to generate a voltage when subjected to mechanical stress or vibration, or to vibrate when subjected to a high voltage, or both. The piezoelectric thin film 230 may be made of lead zirconate titanate (Pb[ZrₓTi₁₋ₓ]O₃0≦x≦1) (PZT), barium titanate (BaTiO₃), lead titanate (PbTiO₃), lithium niobate (LiNbO₃), or crystal quartz (SiO₂), for example, but is not limited thereto.

In the exemplary embodiments illustrated in FIGS. 3 and 5, it is illustrated that the piezoelectric thin film 230 is arranged at both ends of the post 220. However, the piezoelectric thin film 230 may be arranged at one end of the post 220.

The piezoelectric thin film 230 transfers the converted electric energy to the battery 140. In the illustrated example, the converted electric energy is directly transferred to the battery 140. However, the charger 200 or the battery 140 may further include a rectifying device and/or a transformation device and may rectify or transform the converted electric energy using the corresponding device to charge the battery 140.

The configuration of the charger 200 according to an exemplary embodiment of the present general inventive concept has been described. Hereinafter, the operation of the charger 200 according to the exemplary embodiment will be described with reference to FIG. 4.

FIG. 4 is a view illustrating the operation of the charger 200 of FIG. 2.

Referring to FIG. 4, the electronic apparatus 100 according to this exemplary embodiment is worn on the user's wrist. Accordingly, while the user swings his/her arm, the electronic apparatus 100 moves in accordance with the motion of the wrist.

The vibrator 210 that moves in the gravity direction is provided inside the electronic apparatus 100, and as illustrated in FIG. 4, if the user's watch arm is positioned in the rear of the user, the vibrator 210 is positioned in a direction B by gravity.

In this state, if the user's watch arm moves to the front side, the vibrator 210 moves in a direction A in the post 220. Accordingly, the vibrator 210 moves from B to A, and has kinetic energy. The vibrator 210 having the kinetic energy in the above-described process collides with the piezoelectric thin film 230, and the collision energy is converted into electric energy by the piezoelectric effect. This electric energy is then used to charge the battery 140.

Again, if the user's watch arm moves to the rear side, the vibrator 210 moves in the direction B in the post 220. Accordingly, the vibrator 210 moves from A to B, and has kinetic energy. The vibrator 210 having the kinetic energy in the above-described process collides with the piezoelectric thin film 230, and the collision energy is converted into electric energy by the piezoelectric effect. This electric energy is then used to charge the battery 140.

The method of generating electricity using the piezoelectric effect has been described. Furthermore, an induced electromotive force may be used together with the piezoelectric effect. This will now be described with reference to FIG. 5.

FIG. 5 is a view illustrating a charger 200′ according to an exemplary embodiment of the present general inventive concept. Specifically, the charger 200′ according to an exemplary embodiment of the present general inventive concept uses both the piezoelectric effect and the induced electromotive force.

Referring to FIG. 5, the charger 200′ according to the exemplary embodiment includes a vibrator 210′, a post 220, a piezoelectric thin film 230, and a coil 240.

The vibrator 210′ according to the exemplary embodiment is a permanent magnet 211. Specifically, the vibrator 210′ according to the exemplary embodiment, which is movable in the space provided in the post 220, is a permanent magnet having an N-pole arranged in one direction of the post 220 and an S-pole arranged in the other direction of the post 220. The vibrator 210′ slides in the space in the post 220, and through this movement, an electromotive force may be induced in the coil 240 to be described later.

The post 220 has the space of a preset shape in which the vibrator 210′ is movable. The post 220 is made of a heatproof material against the movement of the vibrator 210′, and it is preferable that the post 220 has good permeability of magnetic flux.

The piezoelectric thin film 230 is arranged on at least one side of the post 220 to convert the impact pressure applied to the piezoelectric thin film 230 by the permanent magnet 211 into electric energy using the piezoelectric effect. Since the function and operation of the piezoelectric thin film 230 are the same as those of the piezoelectric thin film 230 of FIG. 4, the detailed explanation thereof will be omitted.

The coil 240 is a solenoid coil that surrounds an outside of the post 220. Here, the solenoid is a device obtained by winding a conducting wire closely and uniformly in a cylindrical shape, and generates the induced electromotive force according to the movement of the permanent magnet 211. As illustrated in FIG. 5, the coil 240 may be arranged on an outer surface of the post 220 on a path in which the permanent magnet 211 moves.

The configuration of the charger 200 according to the exemplary embodiment has been described. Hereinafter, referring again to FIG. 4 as described above, the operation of the charger 200′ according to the exemplary embodiment will be described.

The electronic apparatus 100 having the charger 200′ according to the exemplary embodiment illustrated in FIG. 5 may be worn on the user's wrist, similarly to the exemplary embodiment illustrated in FIG. 4. Accordingly, while the user swings his/her arm, the electronic apparatus 100 moves in accordance with the motion of the wrist.

On the other hand, a permanent magnet 211 that moves in the gravity direction is provided inside the electronic apparatus 100, and as illustrated in FIG. 4, if the user's watch arm is positioned in the rear of the user, the permanent magnet 211 is moved in the B direction by gravity.

In this state, if the user's watch arm moves to the front side of the user, the permanent magnet 211 moves in the A direction in the post 220. As the permanent magnet 211 moves inside the coil 240 that is a solenoid coil, an induced electromotive force is generated.

In other words, if the user's watch arm moves to the front side, the permanent magnet 211 moves in the A direction in the post 220. Accordingly, the permanent magnet 211 moves from B to A, and has kinetic energy. If the permanent magnet 211 moves from B to A in this fashion, an induced electromotive force is generated in the coil 240 in the same manner as a case where a permanent magnet moves in a solenoid coil. The induced electromotive force may be used to charge the battery 140.

Further, the permanent magnet 211 having the kinetic energy in the above-described process collides with the piezoelectric thin film 230, and the collision energy is converted into the electric energy by the piezoelectric effect, and used to charge the battery 140, in addition to the electric energy generated by the induced electromotive force.

As described above, the charger 200′ according to the exemplary embodiment can generate more electricity through the movement of the permanent magnet 211 using both the piezoelectric thin film 230 and the induced electromotive force.

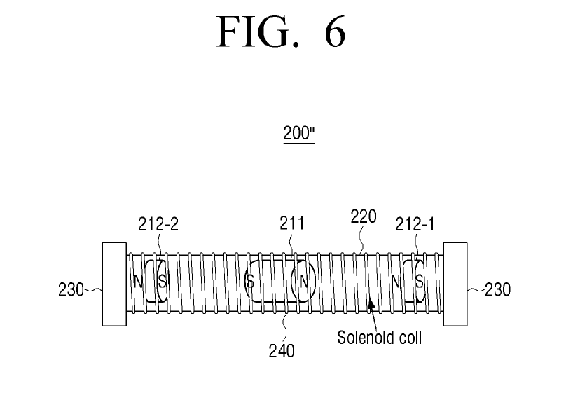

FIG. 6 is a view illustrating a charger 200″ according to an exemplary embodiment of the present general inventive concept. Specifically, the charger 200″ according to an exemplary embodiment uses both the piezoelectric effect and the induced electromotive force, and includes a plurality of permanent magnets 211 and 212.

Referring to FIG. 6, the charger 200″ according to the exemplary embodiment includes the plurality of permanent magnets 211 and 212, a post 220, a piezoelectric thin film 230, and a coil 240.

The charger 200″ of FIG. 6 may be the same as the charger of FIG. 5 except that the plurality of permanent magnets 211 and 212 are used. That is, the configurations of the post 220, the piezoelectric thin film 230, and the coil 240 are the same as those in FIG. 5, and thus the detailed explanation thereof will be omitted.

The vibrator 210″ according to the exemplary embodiment is implemented by a first auxiliary permanent magnet 212-1, a main permanent magnet 211, and a second auxiliary permanent magnet 212-2, which are successively arranged in the space of the post 220 between two piezoelectric thin films 230. In this case, the first auxiliary permanent magnet 212-1 and the second permanent magnet 212-2 have a magnetic flux direction that is different from the magnetic flux direction of the main permanent magnet 211. That is, the main permanent magnet 211 has an S-pole arranged in one direction of the post 220 and an N-pole arranged in the other direction of the post 220, and repulsive forces act between the main permanent magnet 211 and the first and second auxiliary permanent magnets 212-1 and 212-2.

As described above, the charger 200″ according to the exemplary embodiment is implemented by the plurality of permanent magnets 211 and 212, and thus the main permanent magnet 211 can vibrate with relatively narrow amplitude in comparison to the exemplary embodiments illustrated in FIGS. 3 and 5. Specifically, the movement energy that is converted into the repulsive force according to the movement of the main permanent magnet 211 moves the auxiliary permanent magnets 212-1 and 212-2, and the kinetic energy of the auxiliary permanent magnets 212-1 and 212-2 may be converted into the electric energy according to the piezoelectric effect.

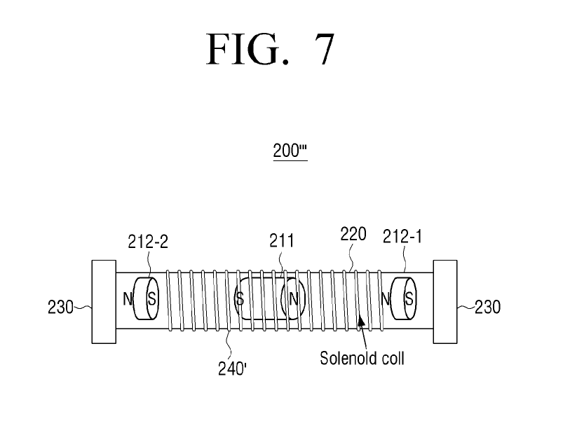

FIG. 7 is a view illustrating a charger 200″′ according to an exemplary embodiment of the present general inventive concept. Specifically, the charger 200″′ according to an exemplary embodiment uses both the piezoelectric effect and the induced electromotive force, and includes a plurality of permanent magnets 211 and 212.

Referring to FIG. 7, the charger 200″′ according to the exemplary embodiment includes a plurality of permanent magnets 211 and 212, a post 220, a piezoelectric thin film 230, and a coil 240′. The charger 200″′ of FIG. 7 is the same as the charger of FIG. 6 except for the shape of the coil 240′. Since the configurations of the plurality of permanent magnets 211 and 212, the post 220, and the piezoelectric thin film 230 are the same as those in FIG. 6, the detailed explanation thereof will be omitted.

Specifically, the first auxiliary permanent magnet 212-1 and the second permanent magnet 212-2 are arranged in the magnetic flux direction that is different from the magnetic flux direction of the main permanent magnet 211. The induced electromotive force by the first auxiliary permanent magnet 212-1 and the second auxiliary permanent magnet 212-2 has different electric potential from the induced electromotive force by the main permanent magnet 211.

Accordingly, in order to maximize the induced electromotive force that is generated from the coil 240′, the coil 240′ may be arranged only on an outer surface of the post 220 on a path in which the main permanent magnet 211 moves, as illustrated in FIG. 7.

On the other hand, although it is described that the chargers according to the above exemplary embodiments are implemented by one post 220, the charger may be implemented by a plurality of posts 220.

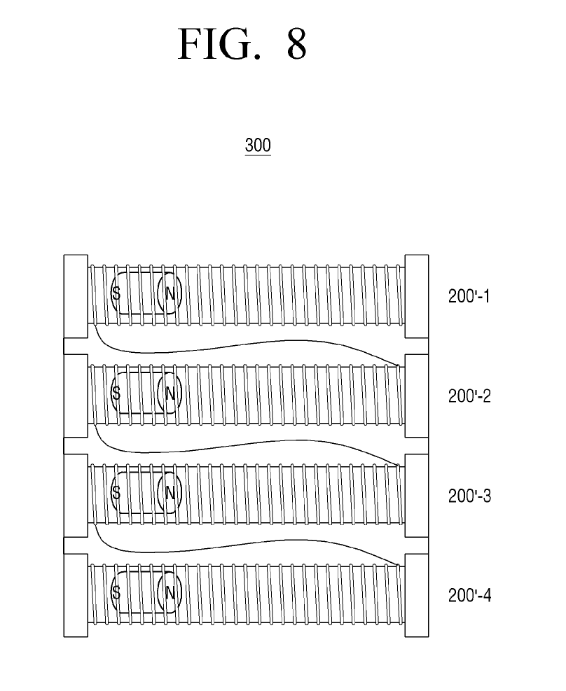

FIG. 8 is a view illustrating a charging module 300 according to an exemplary embodiment of the present general inventive concept. Specifically, the charging module 300 according to the exemplary embodiment includes a plurality of chargers 200′ that are connected in parallel as illustrated in FIG. 8.

Referring to FIG. 8, a charging module 300 according to an exemplary embodiment of the present general inventive concept includes a plurality of chargers 200′, designated as 200′-1, 200′-2, 200′-3, and 200′-4 and referred to herein as chargers 200′. Each charger 200′ corresponds to the charger 200′ of FIG. 5, which are connected in parallel. Although it is described that the charging module 300 is implemented using the plurality of chargers 200′ according to the exemplary embodiment illustrated in FIG. 5, the charging module 300 may be implemented using the chargers according to any of the other exemplary embodiments of the present general inventive concept described herein, or the charging module 300 may be implemented by mixing the chargers according to the various exemplary embodiments, such that different kinds of chargers make up the charging module 300.

Further, in FIG. 8, it is exemplified that the charging module 300 is configured by connecting four chargers in parallel, the charging module 300 may be implemented by connecting only two or three chargers in parallel, or by connecting five or more chargers, depending on the particular embodiment of the present general inventive concept.

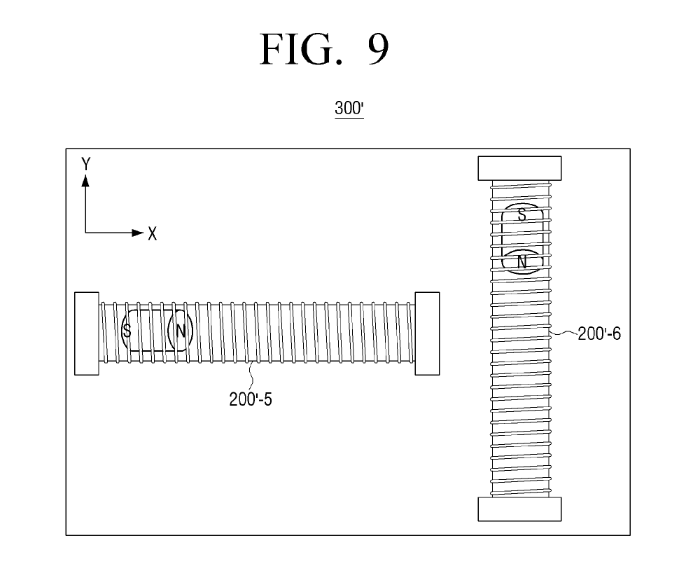

FIG. 9 is a view illustrating a charging module 300′ according to an exemplary embodiment of the present general inventive concept. Specifically, the charging module 300′ according to an exemplary embodiment includes a plurality of chargers 200′ that are arranged in different directions. The plurality of chargers are designated as 200′-5 and 200′-6, and referred to herein as chargers 200′. Each charger 200′ corresponds to the charger 200′ of FIG. 5. However, the charging module 300′ may be implemented with the chargers according to any of the other exemplary embodiments of the present general inventive concept described herein, or a combination thereof.

Referring to FIG. 9, a charging module 300′ according to an exemplary embodiment includes a plurality of chargers 200′ according to the exemplary embodiment described above with respect to FIG. 5, which are arranged in different directions. Specifically, as illustrated in FIG. 9, one charger 200′-5 is arranged in the X direction, and the other charger 200′-6 is arranged in the Y direction perpendicular to the X direction. Using the chargers 200′ that are arranged in different directions as described above, the electric energy can be generated even in the electronic apparatus 100 of which the movement and the direction of the movement is not constant.

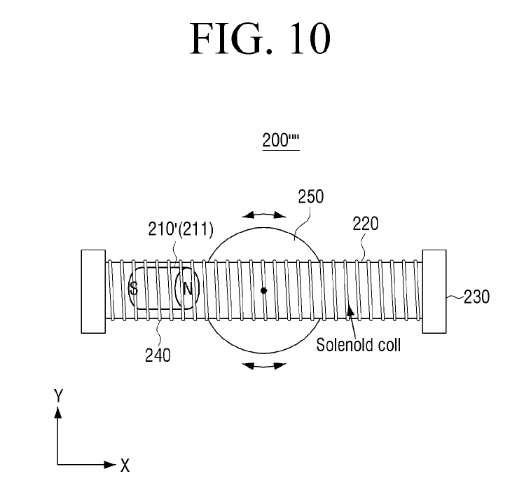

FIG. 10 is a view illustrating a charger 200″″ according to an exemplary embodiment of the present general inventive concept. Specifically, the charger 200″″ according to an exemplary embodiment uses both the piezoelectric effect and the induced electromotive force, and can change the vibration direction.

Referring to FIG. 10, the charger 200″″ according to the exemplary embodiment includes a vibrator 210′, a post 220, a piezoelectric thin film 230, a coil 240, and a rotator 250. The charger 200″″ of FIG. 10 is similar to the charger 200′ of FIG. 5 except that the rotator 250 is additionally provided. That is, since the configurations of the vibrator 210′, the post 220, the piezoelectric thin film 230, and the coil 240 are the same as those of FIG. 5, the duplicate explanation thereof will be omitted.

The rotator 250 moves in the arrangement direction of the post 220 to correspond to the moving direction of the electronic apparatus 100. Specifically, the rotator 250 may be implemented by a sensor (not illustrated) that senses the vibration direction of the electronic apparatus 100 and a motor (not illustrated) that moves the arrangement direction of the post 220 in the direction of the arrows illustrated in FIG. 10, and may be mechanically implemented.

As described above, the charger 200″″ according to the exemplary embodiment can vary the arrangement direction of the charger 200″″, and thus can be applied to an electronic apparatus 100 of which the moving direction is not regular.

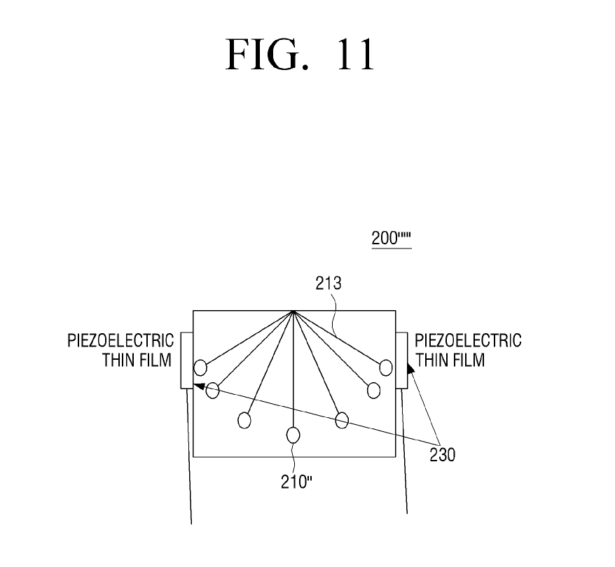

FIG. 11 is a view illustrating a charger 200″″′ according to an exemplary embodiment of the present general inventive concept. Specifically, the charger 200″″′ according to an exemplary embodiment uses the piezoelectric effect.

Referring to FIG. 11, the charger 200″″′ according to the exemplary embodiment includes a vibrator 210″, of which one side is connected to one side of the electronic apparatus 100 through a thread 213, and a plurality of piezoelectric thin films 230.

The vibrator 210″ collides with the piezoelectric thin film 230 during physical pendulum motion, and the piezoelectric thin film 230 converts the collision energy into electric energy.

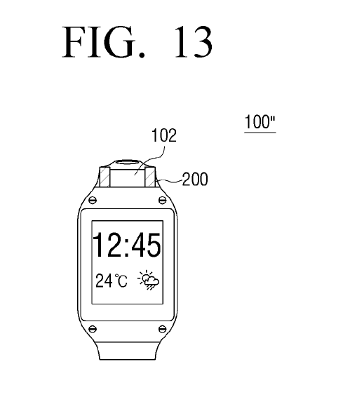

FIGS. 12 and 13 are views illustrating various arrangement examples of the charger 200. It will be understood that the charger 200 illustrated in FIGS. 12 and 13 may be embodied by any of the above exemplary embodiments.

Referring to FIG. 12, an electronic apparatus 100′ includes a first charger 200-1 arranged on the left side of a user interface 120 and a second charger 200-2 arrange on the right side thereof. Since the electronic apparatus 100′ is provided with a plurality of chargers, it can charge the battery 140 faster than the electronic apparatus 100 of FIG. 1.

Referring to FIG. 13, an electronic apparatus 100″ has a charger 200 arranged on a watch strap 102, and thus can perform charging function even in a state where the size of a main body is not increased.

On the other hand, although it is illustrated that the charger is provided on a main body 101 or a watch strap 102, the charger may be arranged on both the main body 101 and the watch strap 102.

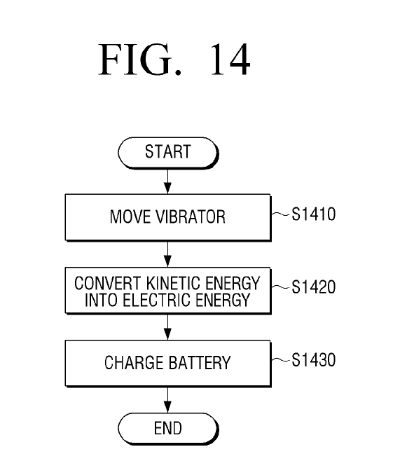

FIG. 14 is a flowchart illustrating a charging method according to an exemplary embodiment of the present general inventive concept.

Referring to FIG. 14, a vibrator moves in an electronic apparatus according to a user's motion (operation S1410). Specifically, the vibrator, which may be arranged in a post having a space of a preset shape in which the vibrator is movable, may perform relative movement in the space of the post according to the movement of the electronic apparatus.

Then, kinetic energy caused by the movement of the vibrator is converted into electric energy (operation S1420). Specifically, impact pressure that is applied to the piezoelectric thin film of the vibrator may be converted into the electric energy using the piezoelectric effect. Alternatively, or in addition, if the vibrator is a permanent magnet and a solenoid coil is wound around the post, an induced electromotive force on the coil along a moving path of the permanent magnet due to the movement of the vibrator may also be converted into the electric energy.

Then, a battery is charged using the converted electric energy (operation S1430). Specifically, the battery may be charged through rectification and transformation of the converted electric energy.

According to the charging method according to this exemplary embodiment of the present general inventive concept, the battery can be charged through conversion of the kinetic energy caused by the user's motion into the electric energy, and thus the operating time of the electronic apparatus 100 can be increased. The charging method illustrated in FIG. 14 may be performed by the electronic apparatus 100 having the configuration of FIG. 2, and may be performed by other electronic apparatuses having other configurations.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a Blu-Ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus comprising:
a user interface configured to display preset information;
a battery configured to supply a power to the user interface; and
a charger provided with a vibrator that is movable in the electronic apparatus and configured to convert kinetic energy caused by movement of the vibrator into electric energy to charge the battery.

2. The electronic apparatus of claim 1, wherein the charger comprises:
the vibrator;
a post having a space of a preset shape in which the vibrator is movable; and
a piezoelectric thin film arranged on at least one side of the post.

3. The electronic apparatus of claim 2, wherein the piezoelectric thin film converts impact pressure applied to the piezoelectric thin film by the vibrator into the electric energy using a piezoelectric effect.

4. The electronic apparatus of claim 2, wherein:
the vibrator is a permanent magnet having an N-pole arranged in a first direction of the post and an S-pole arranged in an opposite direction of the post; and
the charger further comprises a coil surrounding an outer portion of the post.

5. The electronic apparatus of claim 4, wherein the coil generates an induced electromotive force caused by movement of the permanent magnet.

6. The electronic apparatus of claim 4, wherein the charger comprises a first auxiliary permanent magnet, a main permanent magnet, and a second auxiliary permanent magnet, which are successively arranged in the space of the post between two piezoelectric thin films.

7. The electronic apparatus of claim 6, wherein the first or second auxiliary permanent magnet comprises an S-pole arranged in the first direction of the post and an N-pole arranged in the opposite direction of the post.

8. The electronic apparatus of claim 6, wherein the coil is arranged on an outer surface of the post on a path in which the main permanent magnet moves.

9. The electronic apparatus of claim 4, wherein the coil is arranged on an outer surface of the post on a path in which the permanent magnet moves.

10. The electronic apparatus of claim 2, wherein the post is in a cylindrical shape having a preset permeability of magnetic flux.

11. The electronic apparatus of claim 1, wherein the battery is chargeable using a DC power provided from an external source.

12. The electronic apparatus of claim 1, further comprising a plurality of chargers.

13. The electronic apparatus of claim 12, wherein the plurality of chargers are arranged in different directions on the electronic apparatus.

14. The electronic apparatus of claim 1, wherein the electronic apparatus is in the form of a watch that is wearable on a user's wrist.

15. The electronic apparatus of claim 14, wherein the charger is arranged so that the vibrator moves in a direction that is perpendicular to a display direction of the user interface.

16. The electronic apparatus of claim 14, wherein the charger is arranged on a watch strap of the watch.

17. The electronic apparatus of claim 1, wherein the preset information is current time information.

18. A method of charging an electronic apparatus that displays preset information, the method comprising:
moving a vibrator in the electronic apparatus in accordance with a user's motion;
converting kinetic energy caused by movement of the vibrator into electric energy; and
charging a battery using the converted electric energy.

19. The method of claim 18, wherein the converting converts impact pressure applied to a piezoelectric thin film of the vibrator into the electric energy using a piezoelectric effect.

20. The method of claim 18, wherein:
the vibrator is a permanent magnet; and
the converting uses an induced electromotive force of a coil on a moving path of the permanent magnet caused by movement of the permanent magnet.
